(19) United States
(12) Patent Application Publication
(10) Pub. No.: US 2010/0145632 A1
(43) Pub. Date: Jun. 10, 2010

(54) METHOD, APPARATUS AND SYSTEM FOR INCOMPRESSIBLE FLUID SIMULATIONS, AND STORAGE MEDIUM STORING PROGRAM FOR EXECUTING THE METHOD

(75) Inventors: Byung Seok ROH, Daejeon (KR); Seung Taik Oh, Daejeon (KR); Bon Ki Koo, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/487,256

(22) Filed: Jun. 18, 2009

(30) Foreign Application Priority Data
Dec. 10, 2008 (KR) 10-2008-012552

(51) Int. Cl. G01F 1/00; G01N 11/00; G01N 13/02; G01N 9/32; G06F 19/00

(52) U.S. Cl. 702/45; 73/861; 73/54.01; 73/64.49; 73/32 R

(57) ABSTRACT

A method for incompressible fluid simulations includes: calculating a force acting on each particle forming a fluid; calculating a velocity field satisfying a incompressibility condition of the fluid based on the calculated force; and moving the particle in the velocity field. Further, the calculating a velocity field includes: calculating a temporary velocity of the particle free of compression based on the calculated force; calculating pressure satisfying the incompressibility condition of the particle based on the calculated temporary velocity; and calculating velocity satisfying the incompressibility condition of the particle by applying the calculated pressure.

### CROSS-REFERENCE(S) TO RELATED APPLICATION

The present invention claims priority of Korean Patent Application No. 10-2008-0125522, filed on Dec. 10, 2008, which is incorporated herein by reference.

### FIELD OF THE INVENTION

The present invention relates to incompressible fluid simulations, and more particularly, to a method, apparatus and system for Smoothed Particle Hydrodynamics (SPH) simulations satisfying the incompressibility condition of a fluid, and a storage medium storing a program for executing the method.

### BACKGROUND OF THE INVENTION

A fluid is defined as an amorphous substance such as water, fire, cloud, smoke or the like and there have been studies on fluid animation which concerns simulation and visualization of natural phenomena by fluids such as liquids or gases.

The fluid simulation for such fluid animation is based on the Navier-Stokes equations. These equations rewrite Newton's equation of motion (F=ma) for a fluid, and describe the relationship among acceleration of a fluid, forces acting on the fluid motion, pressure, external force, and viscosity of the fluid. It is known that, in a broad view, the Navier-Stokes equations very accurately define the motion of most fluids.

Originally, the Navier-Stokes equations are defined in continuous space, and a crucial issue herein is that which method should be used to calculate the same in a computer. Two calculation methods are largely used: grid-based method and particle-based method.

The grid-based method is a method for dividing space into grids of a same size and calculating characteristics of a fluid in each grid. It is known to be suitable for describing a smooth surface of water. The particle-based method describes a fluid in terms of particles that interact via forces with each other. The final form of a fluid is calculated by tracing the motion of particles, and thus, it is suitable to calculate an intensive motion of the fluid.

There are also several techniques used for the particle-based fluid simulation. One of them, which has recently drawn the attention, is a Smoothed Particle Hydrodynamics (SPH) technique. The SPH technique describes a smooth and continuous space formed of numerous molecules of a fluid with a relatively very small number of particles.

FIG. 1 shows a flow chart for explaining a conventional fluid simulation method based on an SPH technique.

The typical fluid simulation method shown in FIG. 1 includes step S11 of calculating a force acting on particles that form a fluid, step S13 of calculating a velocity field of the fluid, step S15 of moving the particles in the calculated velocity field and step S17 of calculating pressure and density for applying them to calculate the force acting on the respective particles.

However, this fluid simulation method using the SPH technique had a problem in that the method cannot satisfy the incompressibility condition of a fluid due to the absence of a process of keeping the fluid in an incompressible state.

### SUMMARY OF THE INVENTION

Therefore, the present invention provides a method for incompressible fluid simulations based on an SPH technique that satisfies the incompressibility condition of a fluid.

The present invention further provides a storage medium which stores a program for executing the method for incompressible fluid simulations on a computer.

The present invention further provides an apparatus for incompressible fluid simulations that can perform the method for incompressible fluid simulations.

The present invention further provides a system for incompressible fluid simulations employing a computer which executes a program read out from a storage medium, in which the method for incompressible fluid simulations is stored in a program format.

### BRIEF DESCRIPTION OF THE DRAWINGS

The objects and features of the present invention will become apparent from the following description of preferred embodiments, given in conjunction with the accompanying drawings, in which:

FIG. 1 shows a flow chart for explaining a conventional fluid simulation method based on an SPH technique;

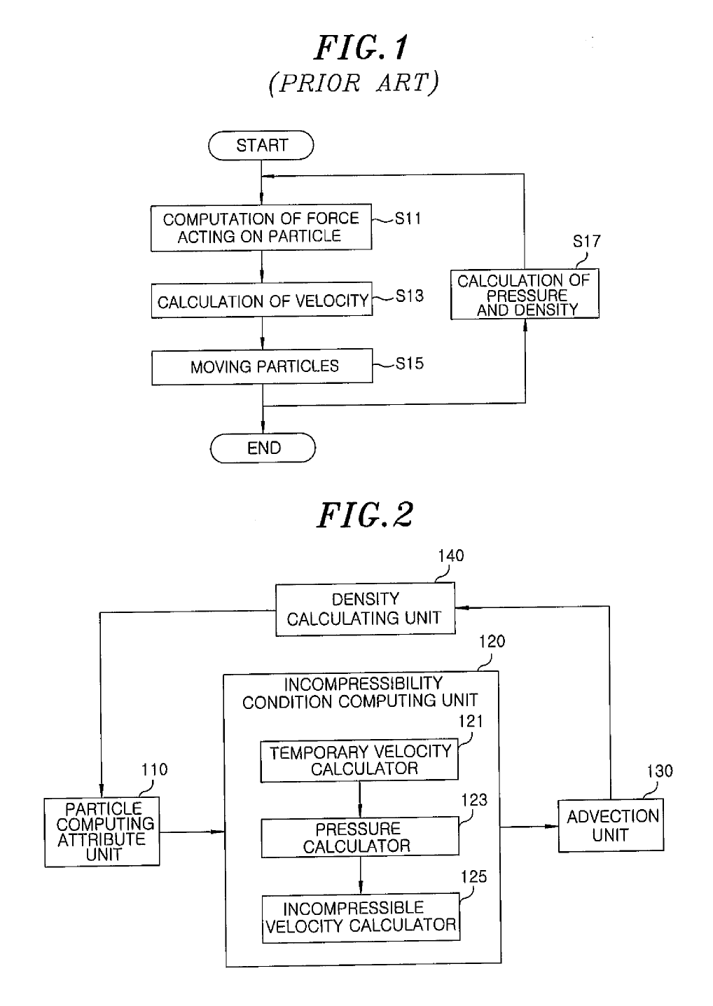

FIG. 2 illustrates a block diagram of an apparatus for fluid simulations to perform a method for incompressible fluid simulations in accordance with an embodiment of the present invention;

FIG. 3 presents a flow chart for explaining a method for incompressible fluid simulations in accordance with the embodiment of the present invention;

FIG. 4 provides a block diagram of a system for incompressible fluid simulations in accordance with another embodiment of the present invention; and

FIGS. 5A to 5C are graphs showing examples of a kernel applied to the present invention.

### DETAILED DESCRIPTION OF THE EMBODIMENT

Hereinafter, embodiments of the present invention will be described in detail with reference to the accompanying drawings which form a part hereof.

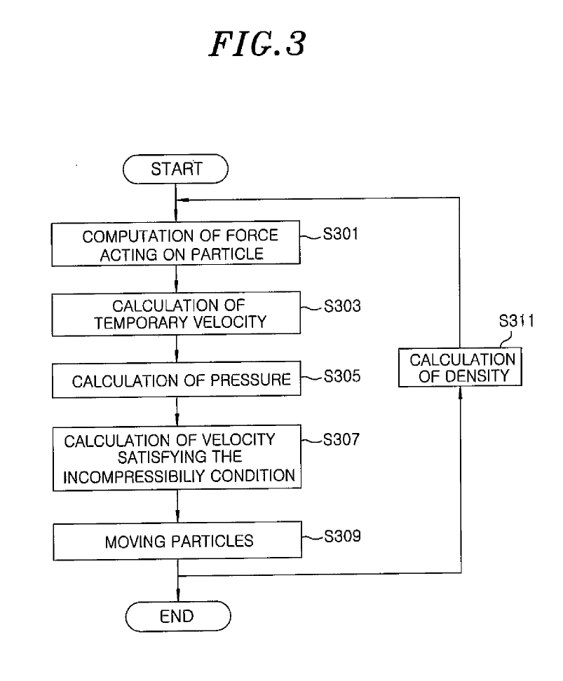

FIG. 2 illustrates a block diagram of an apparatus for fluid simulations capable of performing incompressible fluid simulations in accordance with an embodiment of the present invention.

The fluid simulation apparatus shown in FIG. 2 includes a particle attribute calculating unit 110 for calculating a force such as viscosity, surface tension, gravity and the like, which acts on particles forming a fluid; an incompressibility condition calculating unit 120 for calculating a velocity field that satisfies the incompressibility condition of the fluid based on the calculated force; a moving unit 130 for moving the particles in the calculated velocity field; and a density calculating unit 140 for calculating density of the particles moved by the moving unit 130, and providing the density to the particle attribute calculating unit 110.

The incompressibility condition calculating unit 120 is configured with a temporary velocity calculator 121 for calculating a temporary velocity of a particle free of compression based on the force calculated by the particle attribute calculating unit 110; a pressure calculator 123 for calculating pressure that satisfies the incompressibility condition of a particle based on the calculated temporary velocity; and an incompressible velocity calculator 125 for calculating velocity that satisfies the incompressibility condition of the particle by applying the pressure calculated in the pressure calculator 123.

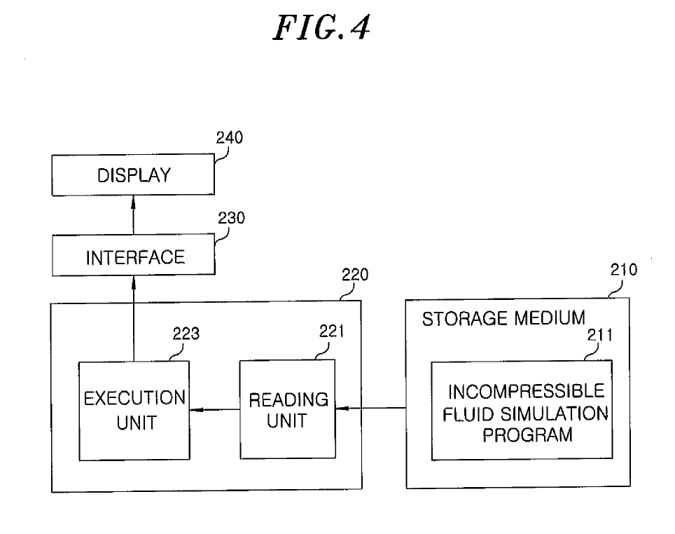

A fluid simulation process carried out by the apparatus for incompressible fluid simulations having the above configuration will now be explained with reference to FIGS. 2 and 3.

In the present invention, an approach for the numerical approximation of the Navier-Stokes equations was made to simulate a real fluid motion. For the sake of illustration, let a velocity field of a fluid at time t be u=u(x,t), and let its differentiation with respect to time t be uₜ. Then, the Navier-Stokes equations that satisfy the incompressibility condition of a fluid can be expressed as Eqs. 1 and 2 below:

ρ(uₜ+u·∇u)=−∇p+ρg+μ∇²u Eq. 1

∇·u=0 Eq. 2

wherein, p=p(x,t) is a kinetostatic pressure of a fluid, g indicates gravity, and μ indicates a viscosity coefficient of a fluid. Further, Eq. 1 is a Navier-Stokes equation defining a fluid flow, and Eq. 2 relates to volume conservation of a fluid.

f=−∇p+ρg+μ∇V²v Eq. 3

As illustrated in Eq. 3, a force f acting on a particle can be written as a sum of pressure (−∇p), gravity (ρg), and viscosity (μ∇²v).

Substituting Eq. 3 in Eq. 1 yields Eq. 4 below:

ρ(uₜ+v·∇v)=f Eq. 4

Eq. 4 is a momentum equation of a real particle. Through Eq. 4, acceleration of an iₜₕ particle can be calculated as follows:

$${a}_{i} = \frac{d {v}_{i}}{d t} = \frac{{f}_{i}}{{ρ}_{i}} \qquad Eq . 5$$

With the acceleration of the iₜₕ particle obtained by Eq. 5, it becomes possible to calculate velocity and location of the iₜₕ particle.

In the present invention, the Navier-Stokes equations, which are equations for fluids, were subject to the numerical approximation through the SPH technique that is suggested by Lucy, Gingold and Monaghan for astrophysics simulation. A scholar value Aᵢ for the iₜₕ particle forming a fluid can be written as follows:

$${A}_{i} ( r ) = {\sum }_{j} {m}_{j} \frac{{A}_{j}}{{ρ}_{j}} W ( r - {r}_{j} , h ) \qquad Eq . 6$$

wherein mⱼ is mass of the jₜₕ particle, ρⱼ indicates density, W(r,h) indicates a smoothing kernel function for radius h, r indicates the location of the iₜₕ particle, rⱼ indicates the location of the jₜₕ particle, and Aⱼ indicates a scalar value of the jₜₕ particle.

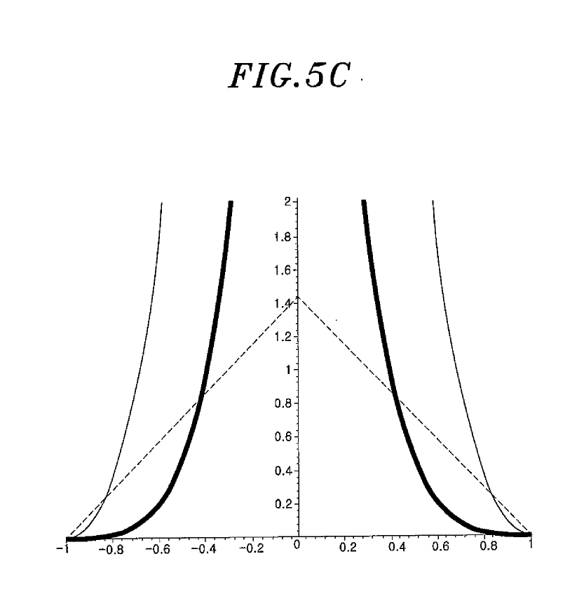

FIGS. 5A to 5C are graphs showing examples of smoothing kernel function W(r,h).

The smoothing kernel function W(r,h) needs to satisfy Eq. 7 below:

W(r,h)=W(−r,h) Eq. 7

Based on Eq. 6, density of the iₜₕ particle is defined as Eq. 8 below:

$${ρ}_{i} ( r ) = {\sum }_{j} {m}_{j} \frac{{ρ}_{j}}{{ρ}_{j}} W ( r - {r}_{j} , h ) = {\sum }_{j} {m}_{j} w ( r - {r}_{j} , h ) \qquad Eq . 8$$

Similar to the above, viscosity, surface tension and the like acting on the iₜₕ particle can be calculated based on Eq. 6 above.

Although it is possible to perform SPH simulation by using Eqs. 1 and 8, the incompressibility condition of a fluid cannot be obtained because there is no proper solution to satisfy Eq. 2.

In this present invention, a temporary velocity u* of the iₜₕ particle with no pressure acting thereto is defined as in Eq. 9 below to satisfy the incompressibility condition of a fluid:

u*=uⁿ+Δt(ρg+μ∇²v+f^{surface}) Eq. 9

wherein f^{surface} indicates surface tension of water, uⁿ indicates velocity when t=n, and Δt indicates time displacement.

In the fluid simulation, velocity when t=n+1 needs to be provided. Therefore, in Eq. 10 below, the velocity when t=n+1 is calculated by applying pressure that is not applied to Eq. 9.

$${u}^{n + 1} = {u}^{*} - \frac{Δ t}{ρ} ∇ p \qquad Eq . 10$$

To make the velocity uⁿ⁺¹ satisfy the incompressibility condition, the pressure p satisfying the incompressibility condition needs to be incorporated in u* calculated without considering the incompressibility condition. In this manner, the present invention can keep a fluid in an incompressible state.

The pressure p satisfying the incompressibility condition is obtained by substituting u* calculated from Eq. 9 into Eq. 2 to derive Eq. 11 below:

$${∇}^{2} p = \frac{1}{Δ t} ∇ \cdot {u}^{*} \qquad Eq . 11$$

After solution of the linear equation Eq. 11 is obtained, the solution is then substituted into Eq. 10 to perform SPH simulation that satisfies the incompressibility condition of a fluid.

FIG. 3 illustrates a flow chart for explaining a method for incompressible fluid simulations in accordance with the embodiment of the present invention.

The fluid simulation method of the present invention includes step S301 of calculating a force acting on each particle that forms a fluid, steps S303 to S307 of calculating a velocity field satisfying the incompressibility condition of the fluid based on the calculated force, step S309 of moving particles in the calculated velocity field, and step S311 of calculating density of particles for applying it to step S301 of calculating the forces after moving the particles.

To be more specific, first, the particle attribute calculating unit 110 calculates the force, i.e., viscosity, surface tension and gravity, acting on each particle in an initial state, by using Eq. 6 or its transformation(s) in step S301. Here, density calculated by the density calculating unit 140 in step S311 is used for calculating the force acting on the particle.

Next, in step S303, the temporary velocity calculator 121 in the incompressibility condition calculating unit 120 calculates a temporary velocity of a particle free of compression, by using Eq. 9 or its transformation(s).

Subsequently, in step S305, the pressure calculator 123 in the incompressibility condition calculating unit 120 calculates pressure that satisfies the incompressibility condition of a particle, by using Eq. 11 or its transformation(s) based on the temporary velocity calculated by the temporary velocity calculator 121.

In a following step S309, the incompressible velocity calculator 125 in the incompressibility condition calculating unit 120 calculates the velocity satisfying the incompressibility condition of a particle, by using Eq. 10 or its transformation that applies the pressure calculated by the pressure calculator 123.

Thereafter, a velocity field satisfying the incompressible condition is calculated by the incompressible condition calculating unit 120 based on the velocity calculated by using the temporary velocity and pressure to satisfy incompressible condition in this manner. The obtained velocity field is then provided to the moving unit 130. Thereafter, the moving unit 130 moves particles in the velocity field from the incompressible condition calculating unit 120. Finally, in step S311, the density calculating unit 140 calculates a density value of particles after their movement, by using Eq. 8 or its transformation(s), and provides the calculated density value to the particle attribute calculating unit 110 to use it for calculating the force acting on the particle in step S301.

Meanwhile, the method for incompressible fluid simulations in accordance with the present invention explained so far with reference to FIG. 3 may also be provided in another embodiment. For example, it may be made in a program format to be executed on a computer and then stored on a storage medium, it may be provided in an online transmission manner through a network, or it may be transmitted in a form of a computer data signal coupled with carrier over a transmission medium or the communication network.

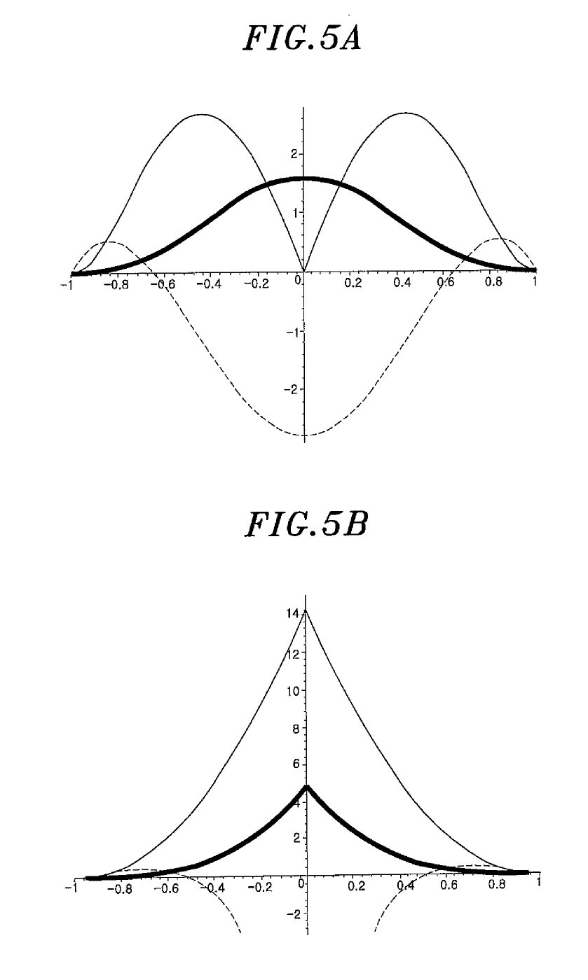

FIG. 4 illustrates a block diagram of a system for incompressible fluid simulations in accordance with another embodiment of the present invention.

As shown, the fluid simulation system in accordance with the another embodiment of the invention includes a computer-readable storage medium 210 that stores an incompressible fluid simulation program 211 to execute, on a computer, a series of steps of calculating force acting on each particle forming a fluid, calculating a velocity field satisfying the incompressibility condition of the fluid based on the calculated force, and moving particles in the velocity field. The system further may include a computer 220 for reading out the incompressible fluid simulation program 211 from the storage medium 210 to execute it; and a display 240 for visually displaying results executed by the computer 220.

The incompressible fluid simulation program 211 stored in the storage medium 210 is built by implementing a computer program with the method for incompressible fluid simulations in accordance with the present invention. Codes and code segments of the incompressible fluid simulation program 211 can easily be inferred by skilled computer programmer in the related art.

The storage medium 210 is a computer-readable medium, so that the computer 220 can reads out the incompressible fluid simulation program 211 from the storage medium 220 and executes it to realize the method for incompressible fluid simulations in accordance with the present invention. The storage medium 210 includes various storage devices that store data readable by the computer 220. The computer-readable devices include, e.g., ROMs, RAMs, CD-ROMs, DVD-ROMs, magnetic tapes, floppy disks, hard disks, optical data storage devices and the like. In addition, such computer-readable storage medium can be distributed in a networked computer unit and stored in a form of computer-readable code of distribution system to be executed.

As mentioned above, the computer 220 reads out the incompressible fluid simulation program 211 stored in the storage medium 210 and executes it. To this end, the computer 220 includes a reading unit 221 for reading out the incompressible fluid simulation program 211 stored in the recording medium 210, and an execution unit 223 for executing the read-out program. The reading unit 221 may be a magnetic head, an optical pickup device, a flash memory reader or the like. The execution unit 223 may be a microprocessor, a firmware-driven chip, a memory or the like.

The interface 230 delivers information on the results of simulations executed by the execution unit 223 to the display 240.

The display 240 then visually displays the results executed on the computer. The display 240 may be a CRT monitor, an LCD monitor, a PDP display, a projector or the like.

As described above, unlike a typical SPH-based fluid simulation incapable of keeping a fluid in an incompressible state, the SPH-based fluid simulation in accordance with the present invention satisfies the incompressibility condition of a fluid, thereby providing more realistic fluid simulation effects.

While the invention has been shown and described with respect to the particular embodiments, it will be understood by those skilled in the art that various changes and modification may be made without departing from the scope of the invention as defined in the following claims.

What is claimed is:

1. A method for incompressible fluid simulations, comprising:
calculating force acting on each particle forming a fluid;
calculating a velocity field satisfying an incompressibility condition of the fluid based on the calculated force; and
moving the particle in the velocity field.

2. The method of claim 1, wherein said calculating the force includes calculating viscosity, surface tension and gravity of the particle.

3. The method of claim 2, wherein, in said calculating the force, a scholar value Aᵢ of an iₜₕ particle is calculated by using the following equation:
$${A}_{i} ( r ) = {\sum }_{j} {m}_{j} \frac{{A}_{j}}{{ρ}_{j}} W ( r - {r}_{j} , h ) ,$$
wherein mⱼ is mass of a jₜₕ particle, ρⱼ indicates density, W(r,h) indicates a smoothing kernel function for radius h, r indicates the location of the iₜₕ particle, rⱼ indicates the location of the jₜₕ particle, and Aⱼ indicates a scalar value of the jₜₕ particle.

4. The method of claim 1, wherein said calculating the velocity field includes:
calculating a temporary velocity of particle free of compression based on the calculated force;
calculating pressure satisfying the incompressibility condition of the particle based on the calculated temporary velocity; and
calculating velocity satisfying the incompressibility condition of the particle by applying the calculated pressure.

5. The method of claim 4, wherein, in said calculating the temporary velocity, a temporary velocity u* of the iₜₕ particle with no pressure acting thereto is calculated by using the following equation:
u*=uⁿ+Δt(ρg+μ∇²v+f^{surface}),
wherein f^{surface} indicates surface tension of water, ρg indicates gravity, and μ∇²v indicates viscosity, uⁿ indicates velocity when t=n, and Δt indicates time displacement.

6. The method of claim 4, wherein the pressure is calculated the pressure p by using the following equation:
$${∇}^{2} p = \frac{1}{Δ t} ∇ \cdot {u}^{*}$$
wherein the equation is obtained by substituting the calculated temporary velocity u* into ∇·u=0 that satisfies the incompressibility condition.

7. The method of claim 4, wherein the velocity uⁿ⁺¹ is calculated by using the following equation:
$${u}^{n + 1} = {u}^{*} - \frac{Δ t}{ρ} ∇ p$$
based on the calculated temporary velocity u* and the pressure p that satisfies the incompressibility condition of the particle.

8. The method of claim 1, further comprising, after moving the particle, calculating density ρⱼ of the particle,
wherein the calculated particle density is used for the calculation of the pressure.

9. The method of claim 8, wherein the density ρⱼ of the iₜₕ particle is calculated by the following equation:
$${ρ}_{i} ( r ) = {\sum }_{j} {m}_{j} \frac{{ρ}_{j}}{{ρ}_{j}} W ( r - {r}_{j} , h ) = {\sum }_{j} {m}_{j} w ( r - {r}_{j} , h )$$
wherein mⱼ is mass of a jₜₕ particle, ρⱼ indicates density, W(r,h) indicates a smoothing kernel function for radius h, r indicates the location of the iₜₕ particle, and rⱼ indicates the location of the jₜₕ particle.

10. A computer-readable storage medium storing a program to execute, on a computer, the method for incompressible fluid simulations described in claim 1.

11. An apparatus for incompressible fluid simulations, comprising:
a particle attribute calculating unit for calculating force acting on each particle forming a fluid;
an incompressible condition calculating unit for calculating a velocity field satisfying a incompressibility condition of the fluid based on the calculated force; and
a moving unit for moving the particle in the velocity field.

12. The apparatus of claim 11, wherein the particle attribute calculating unit further calculates viscosity, surface tension and gravity of the particle.

13. The apparatus of claim 12, wherein the particle attribute calculating unit calculates a scholar value Aᵢ of an iₜₕ particle forming a fluid by using the following equation:
$${A}_{i} ( r ) = {\sum }_{j} {m}_{j} \frac{{A}_{j}}{{ρ}_{j}} W ( r - {r}_{j} , h ) ,$$
wherein mⱼ is mass of a jₜₕ particle, ρⱼ indicates density, W(r,h) indicates a smoothing kernel function for radius h, r indicates the location of the iₜₕ particle, rⱼ indicates the location of the jₜₕ particle, and Aⱼ indicates a scalar value of the jₜₕ particle.

14. The apparatus of claim 11, wherein the incompressible condition calculating unit includes:
a temporary velocity calculator for calculating a temporary velocity of particle free of compression based on the calculated force;
a pressure calculator for calculating pressure satisfying the incompressibility condition of the particle based on the calculated temporary velocity; and
an incompressible velocity calculator for calculating velocity satisfying the incompressibility condition of the particle by applying the calculated pressure.

15. The apparatus of claim 14, wherein the temporary velocity calculator calculates a temporary velocity u* of the iₜₕ particle with no pressure acting thereto by using the following equation:
u*=uⁿ+Δt(ρg+μ∇²v+f^{surface}),
wherein f^{surface} indicates surface tension of water, ρg indicates gravity, and μ∇²v indicates viscosity, uⁿ indicates velocity when t=n, and Δt indicates time displacement.

16. The apparatus of claim 14, wherein the pressure calculator calculates the pressure p satisfying the incompressibility condition of the particle by using the following equation:
$${∇}^{2} p = \frac{1}{Δ t} ∇ \cdot {u}^{*}$$
wherein the equation is obtained by substituting the calculated temporary velocity u* into ∇o·u=0 that satisfies the incompressibility condition.

17. The apparatus of claim 14, wherein the incompressible velocity calculator calculates velocity uⁿ⁺¹ by using the following equation:
$${u}^{n + 1} = {u}^{*} - \frac{Δ t}{ρ} ∇ p$$
based on the calculated temporary velocity u* and the pressure p that satisfies the incompressibility condition of the particle.

18. The apparatus of claim 11, further comprising: a density calculator for calculating density ρⱼ of the particle after moving the particular, and providing the calculated particle density to the particle attribute calculating unit.

19. The apparatus of claim 18, wherein the density calculator calculates the density of the iₜₕ particle by the following equation:
$${ρ}_{i} ( r ) = {\sum }_{j} {m}_{j} \frac{{ρ}_{j}}{{ρ}_{j}} W ( r - {r}_{j} , h ) = {\sum }_{j} {m}_{j} w ( r - {r}_{j} , h )$$
wherein mⱼ is mass of a jₜₕ particle, ρⱼ indicates density, W(r,h) indicates a smoothing kernel function for radius h, r indicates the location of the iₜₕ particle, and rⱼ indicates the location of the jₜₕ particle.

20. A system for incompressible fluid simulations, comprising:
a computer-readable storage medium storing a program for executing, on a computer, a method including:
calculating a force acting on each particle forming a fluid;
calculating a velocity field satisfying a incompressibility condition of the fluid based on the calculated force; and
moving the particle in the calculated velocity field;
a computer for reading out and executing the program stored in the storage medium;
a display for visually displaying results executed on the computer.
